(19) United States
(12) Patent Application Publication
(10) Pub. No.: US 2023/0144509 A1
(43) Pub. Date: May 11, 2023

(54) A PLURALITY OF ROBOT CLEANERS AND METHOD FOR CONTROLLING THE SAME

(71) Applicant: LG ELECTRONICS INC., Seoul (KR)

(72) Inventors: Hyeokjoo YUN, Seoul (KR); Hwan YOO, Seoul (KR); Jinwoo HAN, Seoul (KR)

(21) Appl. No.: 17/918,210

(22) PCT Filed: Oct. 27, 2020
(86) PCT No.: PCT/KR2020/014744

§ 371 Date: Oct. 11, 2022

(30) Foreign Application Priority Data
Apr. 8, 2020 (KR) 10-2020-0042858

(51) Int. Cl. A47L 11/40

(52) U.S. Cl. CPC A47L 11/4011; A47L 2201/06; A47L 2201/02

(57) ABSTRACT

Disclosed is a method of controlling a plurality of robot cleaners, the method including a first step of docking a first robot cleaner and a second robot cleaner with a first docking device and a second docking device, respectively, a second step of checking whether the first robot cleaner is undocked from the first docking device, and a third step of if the first robot cleaner docked with the first docking device again, undocking the second robot cleaner from the second docking device.

### TECHNICAL FIELD

The present disclosure relates to a plurality of robot cleaners and method for controlling the same, and more particularly, to a plurality of robot cleaners and method for controlling the same that are suitable for two robot cleaners to perform cleaning without interference therebetween.

### BACKGROUND ART

In general, a cleaner includes a main body having a suction device and a dust container and a cleaning nozzle connected to the main body to perform cleaning in a state of being proximate to a face to be cleaned. Cleaners are categorized into a manual cleaner for a user to clean a face to be cleaned directly and manually and a robot cleaner to clean a face to be cleaned while a main body travels by itself.

In addition, regarding the robot cleaner, an ultrasonic sensor, a camera sensor and/or the like are further installed in the main body equipped with the suction device and the dust container. As the main body automatically travels around a face to be cleaned, the cleaning nozzle sucks foreign substance on the face to be cleaned by a suction force generated by the suction device and the sucked foreign substance is collected in the dust container. Thus, the cleaning of the face to be cleaned is performed.

As a prior art, there is Korean Patent Application 10-2017-0174493. However, since the prior art just discloses a general technology of operating two robot cleaners, it is necessary to suggest a technology of efficiently performing cleaning while two robot cleaners are operating.

In addition, as the prior art assumes that the two robot cleaners communicate with each other, it is necessary to suggest a technology of performing cleaning with two robot cleaners despite absence of communication between the two robot cleaners.

### DISCLOSURE OF INVENTION

### Technical Problem

One technical task of the present disclosure is to provide a plurality of robot cleaners and method for controlling the same, by which a plurality of robots can do the cleaning without user's intervention.

Another technical task of the present disclosure is to provide a plurality of robot cleaners and method for controlling the same, by which two robots can do the cleaning cooperatively in a situation that robot cleaners are unable to communicate with each other.

Further technical task of the present disclosure is to provide a plurality of robot cleaners and method for controlling the same, by which interference is prevented from occurring among the robot cleaners when a plurality of the robot cleaners are simul-taneously cleaning a traveling zone despite the possibility of collision or cleaning interference between the robot cleaners during the cleaning in a predetermined area.

### Solution to Problem

In order to achieve the above technical tasks, the present disclosure provides a technology that traveling interference does not occur between a second robot cleaner and a first robot cleaner. Since the second robot cleaner is docked with a second cocking device while the first robot cleaner is cleaning, interference does not occur between the traveling of the first robot cleaner and the travelling of the second robot cleaner. On the other hand, since the first robot cleaner is docked with a first cocking device while the second robot cleaner is cleaning, interference does not occur between the traveling of the first robot cleaner and the travelling of the second robot cleaner.

In addition, the present disclosure suggests a technology that two robot cleaners can do the cleaning cooperatively despite not communicating with each other through communication units. One of the robot cleaners may determine whether the other is currently cleaning or whether the other is currently docked with a docking device depending on a presence or non-presence of reception of a signal transmitted from the docking device with which the corresponding robot cleaner is not docked. Namely, the present disclosure suggests a method of using cooperative travelling even in an offline environment.

To achieve these objects and other advantages and in accordance with the purpose of the present disclosure, as embodied and broadly described herein, a method of controlling a plurality of robot cleaners according to one embodiment of the present disclosure may include a first step of docking a first robot cleaner and a second robot cleaner with a first docking device and a second docking device, respectively, a second step of checking whether the first robot cleaner is undocked from the first docking device, and a third step of if the first robot cleaner docked with the first docking device again, undocking the second robot cleaner from the second docking device.

In another aspect of the disclosure, as embodied and broadly described herein, a plurality of robot cleaners according to one embodiment of the present disclosure may include a first docking device including a guide signal generating unit transmitting a docking guide signal, a second docking device including a guide signal generating unit transmitting a docking guide signal, a first robot cleaner docked with the first docking device, and a second robot cleaner docked with the second docking device, wherein a sensing unit is provided to each of the first robot cleaner and the second robot cleaner and wherein the sensing unit is capable of receiving a signal of the guide signal generating unit of the first docking device and a signal of the guide signal generating unit of the second docking device.

It is to be understood that both the foregoing general description and the following detailed description are exemplary and explanatory and are intended to provide further explanation of the disclosure as claimed.

### Advantageous Effects of Invention

According to the present disclosure, a plurality of robot cleaners can do the cleaning while cooperating with each other. For example, when two robot cleaners include robot cleaners of different types, cleaning may be performed in two ways without user's intervention.

### BRIEF DESCRIPTION OF DRAWINGS

The accompanying drawings, which are included to provide a further understanding of the disclosure and are incorporated in and constitute a part of this specification, illustrate embodiments of the disclosure and together with the description serve to explain the principles of the disclosure.

FIG. 1 is a perspective diagram showing a robot cleaner and a docking device with which the robot cleaner is docked according to an embodiment of the present disclosure.

FIG. 2 is a diagram showing the robot cleaner of FIG. 1, viewed from a topside.

FIG. 3 is a diagram showing the robot cleaner of FIG. 1, viewed from a front side.

FIG. 4 is a diagram showing the robot cleaner of FIG. 1, viewed from a bottom side.

FIG. 5 is a block diagram showing the control configuration among main components of the robot cleaner of FIG. 1.

FIG. 6 is a conceptual diagram showing the network including a plurality of the robot cleaners of FIG. 1 and a terminal.

FIG. 7 is a control flowchart according to an embodiment of the present disclosure.

FIG. 8 is a flowchart to describe an essential portion of FIG. 7.

FIG. 9 is a flowchart to describe another essential portion of FIG. 7.

FIG. 10 is a diagram to describe implementation of an embodiment according to FIG. 7.

### MODE FOR THE INVENTION

Hereinafter, a preferred embodiment of the present disclosure that may specifically realize the above objects will be described with reference to the accompanying drawings.

In this process, a size, a shape, or the like of a component shown in the drawings may be exaggerated for clarity and convenience of the description. In addition, terms specifically defined in consideration of a configuration and an operation of the present disclosure may vary depending on a user or an operator's intention or practice. Def-initions of such terms should be made based on the contents throughout this specification.

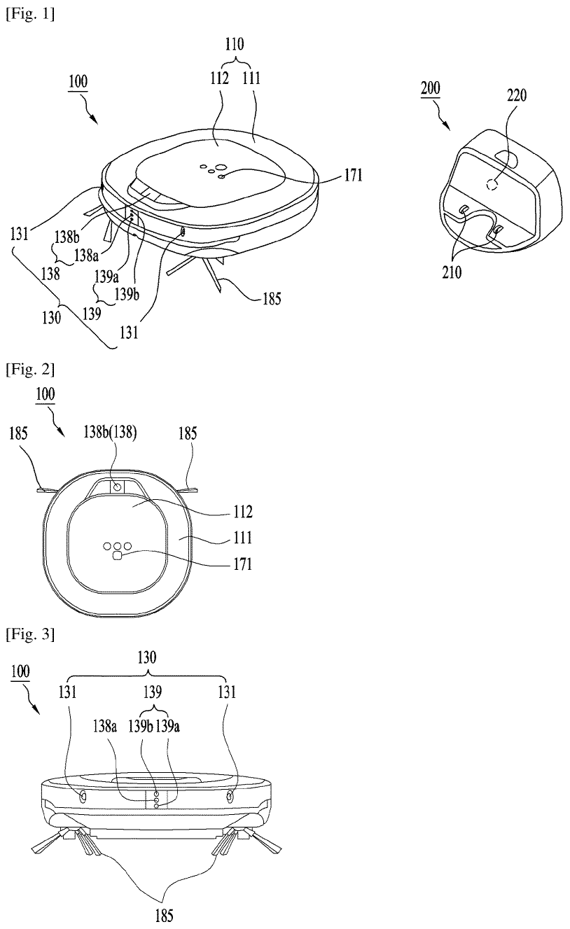

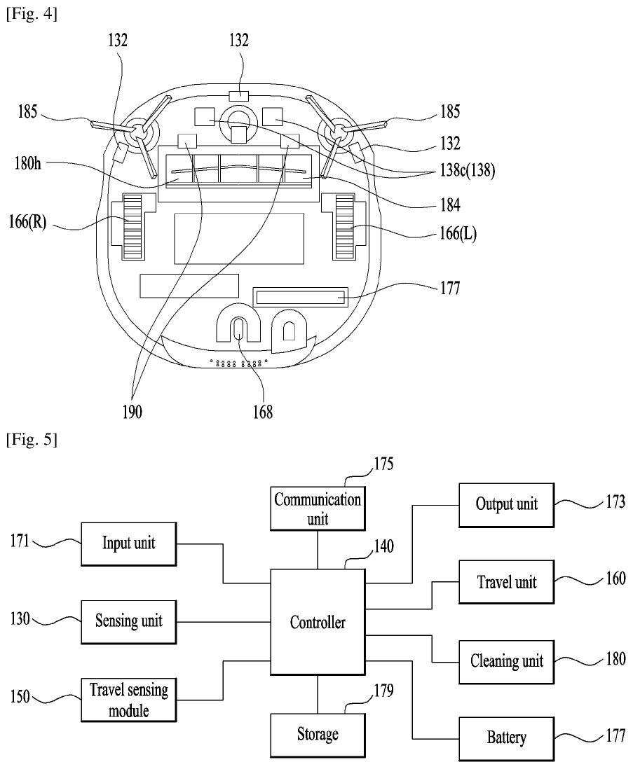

Referring to FIGS. 1 to 6, a robot cleaner 100 includes a main body 110. Hereinafter, in defining each portion of the main body 110, a portion facing a ceiling in a travel zone is defined as a top face (see FIG. 2), a portion facing a floor in the travel zone is defined as a bottom face (see FIG. 4), and a portion directed in a travel direction among portions forming a perimeter of the main body 110 between the top face and the bottom face is defined as a front face (see FIG. 3). In addition, a portion directed in an opposite direction to the front face of the main body 110 may be defined as a rear face. The main body 110 may include a casing 111 for defining therein a space in which various components constituting the robot cleaner 100 are accommodated.

The robot cleaner 100 includes a sensing unit 130 that performs sensing to obtain current state information. The sensing unit 130 may perform the sensing during travel. The sensing unit 130 may sense a situation around the robot cleaner 100. The sensing unit 130 may sense a state of the robot cleaner 100.

The sensing unit 130 may sense information on the travel zone. The sensing unit 130 may sense obstacles such as a wall body, furniture, a cliff, and the like on a travel face. The sensing unit 130 may sense a docking device 200. The sensing unit 130 may sense information about the ceiling. Through the information sensed by the sensing unit 130, the robot cleaner 100 may map the travel zone.

The sensing unit 130 may include at least one of a distance sensor 131, a cliff sensor 132, an external signal sensor (not shown), an impact sensor (not shown), an image sensor 138, 3D sensors 138a, 139a, and 139b, and a docking sensor for sensing whether docking is successful.

The sensing unit 130 may include the distance sensor 131 that senses a distance to a surrounding object. The distance sensor 131 may be disposed on the front face or a side face of the main body 110. The distance sensor 131 may sense a surrounding obstacle.

A plurality of distance sensors 131 may be arranged.

For example, the distance sensor 131 may be an infrared sensor equipped with a light emitter and a light receiver, an ultrasonic sensor, an RF sensor, a geomagnetic sensor, and the like. The distance sensor 131 may be implemented using an ultrasonic wave, an infrared ray, or the like. The distance sensor 131 may be implemented using a camera. The distance sensor 131 may be implemented with two or more types of sensors.

The sensing unit 130 may include the cliff sensor 132 that senses an obstacle on the floor in the travel zone. The cliff sensor 132 may sense whether a cliff exists on the floor.

The cliff sensor 132 may be disposed on the bottom face of the robot cleaner 100. A plurality of cliff sensors 132 may be arranged. The cliff sensor 132 disposed on a front portion of the bottom face of the robot cleaner 100 may be disposed. The cliff sensor 132 disposed on a rear portion of the bottom face of the robot cleaner 100 may be disposed.

The cliff sensor 132 may be an infrared ray sensor equipped with a light emitter and a light receiver, an ultrasonic sensor, an RF sensor, a location sensitive detector (PSD) sensor, and the like. For example, the cliff sensor may be the PSD sensor, but may be composed of a plurality of different types of sensors. The PSD sensor includes a light emitter that emits an infrared ray on the obstacle and a light receiver that receives the infrared ray that is reflected back from the obstacle.

The sensing unit 130 may include the impact sensor that senses an impact resulted from contact between the robot cleaner 100 and the external object.

The sensing unit 130 may include the external signal sensor that senses a signal transmitted from outside of the robot cleaner 100. The external signal sensor may include at least one of an infrared ray sensor that senses an infrared signal from the outside, an ultrasonic sensor that senses an ultrasonic signal from the outside, and an RF sensor (radio frequency sensor) that senses an RF signal from the outside.

The sensing unit 130 may include the image sensor 138 that senses an image of an outside of the robot cleaner 100.

The image sensor 138 may include a digital camera. The digital camera may include an image sensor (e.g., a CMOS image sensor) including at least one optical lens and a plurality of photodiodes (e.g., pixels) on which an image is focused by light passed through the optical lens, and a digital signal processor (DSP) that composes an image based on signals output from the photodiodes. The digital signal processor is capable of generating a moving image composed of frames composed of still images as well as a still image.

The image sensor 138 may include a front face image sensor 138a that senses an image in a forward direction of the robot cleaner 100. The front face image sensor 138a may sense an image of the surrounding object such as the obstacle, the docking device 200, or the like.

The image sensor 138 may include a top face image sensor 138b that senses an image in an upward direction of the robot cleaner 100. The top face image sensor 138b may sense an image such as the ceiling, a bottom face of furniture disposed above the robot cleaner 100, and the like.

The image sensor 138 may include a bottom face image sensor 138c that senses an image in a downward direction of the robot cleaner 100. The bottom face image sensor 138c may sense an image of the floor.

In addition, the image sensor 138 may include a sensor that senses an image in a lateral or rearward direction.

The sensing unit 130 may include the 3D sensors 138a, 139a, and 139b that sense 3D information of an external environment.

The 3D sensors 138a, 139a, and 139b may include a 3D depth camera 138a that calculates a distance between the robot cleaner 100 and an object to be captured.

In the present embodiment, the 3D sensors 138a, 139a, and 139b include a pattern irradiator 139 for irradiating light of a predetermined pattern in the forward direction of the main body 110, and a front face image sensor 138a that acquires an image of a front of the main body 110. The pattern irradiator 139 may include a first pattern irradiator 139a for irradiating light of a first pattern in a forward and downward direction of the main body 110 and a second pattern irradiator 139b for irradiating light of a second pattern in a forward and upward direction of the main body 110. The front face image sensor 138a may acquire an image of a region into which the light of the first pattern and the light of the second pattern are incident.

The pattern irradiator 139 may be disposed to irradiate an infrared pattern.

In this case, the front face image sensor 138a may measure a distance between the 3D sensor and the object to be captured by capturing a shape of the infrared pattern projected on the object to be captured.

The light of the first pattern and the light of the second pattern may be irradiated in a form of straight lines crossing each other. The light of the first pattern and the light of the second pattern may be irradiated in a form of horizontal straight lines spaced from each other in a vertical direction.

A second laser may apply laser in form of a single straight line. According to this, a bottom laser is used to sense an obstacle of a bottom part, a top laser is used to sense an obstacle of a top part, and a middle laser between the bottom laser and the top laser is used to sense an obstacle of a middle part.

The sensing unit 130 may include a docking sensor (not shown) that senses whether the robot cleaner 100 is successfully docked with the docking device 200. The docking sensor may be implemented to sense by contact between a corresponding terminal 190 and a charging terminal 210, may be implemented as a sensor disposed separately from the corresponding terminal 190, or may be implemented by sensing a state of a battery 177 during charging. A docking success status and a docking failure status may be sensed by the docking sensor.

The robot cleaner 100 includes a travel unit 160 that moves the main body 110 with respect to the floor. The travel unit 160 may include at least one driving wheel 166 that moves the main body 110. The travel unit 160 may include a driving motor. The driving wheel 166 may include a left wheel 166(L) and a right wheel 166(R) arranged on left and right sides of the main body 110, respectively.

The left wheel 166(L) and the right wheel 166(R) may be driven by one driving motor, but a left wheel driving motor for driving the left wheel 166(L) and a right wheel driving motor for driving the right wheel 166(R) may be separately arranged as needed. The travel direction of the main body 110 may be switched in a left or right direction by making a difference in rotation speeds of the left wheel 166(L) and the right wheel 166(R).

The travel unit 160 may include an auxiliary wheel 168 that does not provide a separate driving force, but supports the main body against the floor.

The robot cleaner 100 may include a travel sensing module 150 that senses the behavior of the robot cleaner 100. The travel sensing module 150 may sense the behavior of the robot cleaner 100 by the travel unit 160.

The travel sensing module 150 may include an encoder (not shown) that senses a travel distance of the robot cleaner 100. The travel sensing module 150 may include an acceleration sensor (not shown) that senses acceleration of the robot cleaner 100. The travel sensing module 150 may include a gyro sensor (not shown) that senses turning of the robot cleaner 100.

Through the sensing of the travel sensing module 150, the controller 140 may obtain information about a travel path of the robot cleaner 100. For example, based on the rotation speed of the driving wheel 166 sensed by the encoder, information about a current or past travel speed, the travel distance, and the like of the robot cleaner 100 may be obtained. For example, based on a turning direction of each of the driving wheels 166(L) and 166(R), information about a current or past direction switching process may be obtained.

The robot cleaner 100 includes a task unit 180 that performs a prescribed task. For example, the task unit 180 may be configured to perform household tasks such as cleaning (e.g., sweep, suction, mop, etc.), washing dishes, cooking, washing laundry, garbage disposal, etc. For another example, the task unit 180 may perform tasks such as finding objects, exterminating bugs, etc. In the present embodiment, it is described that the task unit 180 performs the cleaning task, but there are many examples of the types of the tasks done by the task unit 180.

The robot cleaner 100 may clean the floor by the task unit 180 while moving in the travel zone. The task unit 180 may suck the foreign substance. The task unit 180 may perform mopping.

The task unit 180 may include a suction device for sucking the foreign substance, brushes 184 and 185 for performing sweeping, a dust container (not shown) for storing therein the foreign substance collected by the suction device or the brushes, and/or a mop for performing mopping (not shown), and the like.

A suction hole 180h into which air is sucked may be defined in the bottom face of the main body 110. The suction device (not shown) for providing a suction force to suck the air through the suction hole 180h and the dust container (not shown) for collecting dust sucked together with the air through the suction hole 180h may be arranged in the main body 110.

An opening for insertion and removal of the dust container may be defined in the casing 111, and a dust container cover 112 for opening and closing the opening may be pivotably disposed with respect to the casing 111.

The task unit 180 may include a roll-type main brush 184 exposed through the suction hole 180h and an auxiliary brush 185 located at a front portion of the bottom face of the main body 110 and including multiple wings extending radially. Rotation of such brushes 184 and 185 removes the dust from the floor in the travel zone, and the dust thus separated from the floor is sucked through the suction hole 180h and collected in the dust container.

The robot cleaner 100 includes the corresponding terminal 190 for charging the battery 177 when being docked with the docking device 200. The corresponding terminal 190 is disposed at a location accessible to the charging terminal 210 of the docking device 200 in the docking success state of the robot cleaner 100. In the present embodiment, a pair of the corresponding terminals 190 are arranged on the bottom face of the main body 110.

The robot cleaner 100 may include an input unit 171 for inputting information. The input unit 171 may receive on/off or various commands. The input unit 171 may include a button, a key, a touch-type display, or the like. The input unit 171 may include a microphone for speech recognition.

The robot cleaner 100 may include an output unit 173 for outputting information. The output unit 173 may inform the user of various informations. The output unit 173 may include a speaker and/or a display.

The robot cleaner 100 may include a communication unit 175 that transmits and receives information to and from other external devices. The communication unit 175 may be connected to a terminal device and/or another device located in a specific region in one of wired, wireless, and satellite communication schemes to transmit and receive data.

The communication unit 175 may be configured to communicate with a terminal 300, a wireless router 400, a server 500, and/or the like. The communication unit 175 of the first robot cleaner 100a may be configured to communicate with the communication unit 175 of the second robot cleaner 100b. The communication unit 175 may communicate with other devices such as the terminal 300, another robot cleaner, and the like, located in the specific area.

The communication unit 175 may receive various command signals from the external device such as the terminal 300 and the like. The communication unit 175 may transmit information to be output to the external device such as the terminal 300 and the like. The terminal 300 may output the information received from the communication unit 175.

The robot cleaner 100 includes the battery 177 for supplying a drive power to each component. The battery 177 supplies power for the robot cleaner 100 to perform a behavior based on selected behavior information. The battery 177 is mounted in the main body 110. The battery 177 may be detachably provided to the main body 110.

The battery 177 is configured rechargeable. The robot cleaner 100 is docked with the docking device 200, so that the battery 177 may be charged through connection between the charging terminal 210 and the corresponding terminal 190. When a charge amount of the battery 177 becomes equal to or smaller than a predetermined value, the robot cleaner 100 may start a docking mode for the charging. In the docking mode, the robot cleaner 100 travels to return to the docking device 200.

The robot cleaner 100 includes a storage 179 that stores various informations. The storage 179 may include a volatile or a non-volatile recording medium.

A map for the travel zone may be stored in the storage 179. The map may be input by a terminal and the like that may exchange information with the robot cleaner 100 through the communication unit 175 or may be generated by the robot cleaner 100 as the robot cleaner 100 learns by itself. In the former case, the terminal may be ex-emplified as a remote control, a PDA, a laptop, a smart phone, a tablet, and the like equipped with an application for setting the map.

For one example, a plurality of the robot cleaners 100a and 100b may share the map with each other. A plurality of the robot cleaners 100a and 100b may transceive information on the map with each other through the communication units 175. For another example, a plurality of the robot cleaners 100a and 100b may store maps of their own, respectively but may not share the maps.

The robot cleaner 100 includes the controller 140 that processes and determines various informations such as mapping and/or recognizing a current location. The controller 140 may control overall operations of the robot cleaner 100 through control of various components of the robot cleaner 100. The controller 140 may map the travel zone through the image and recognize the current location on the map. That is, the controller 140 may perform a simultaneous localization and mapping (SLAM) function.

The controller 140 may receive the information from the input unit 171 and process the received information. The controller 140 may receive the information from the communication unit 175 and process the received information. The controller 140 may receive the information from the sensing unit 130 and process the received information.

The controller 140 may control the communication unit 175 to transmit the information.

The controller 140 may control the output of the output unit 173. The controller 140 may control the driving of the travel unit 160. The controller 140 may control the operation of the task unit 180.

In some implementations, the docking device includes the charging terminal 210 configured to be connected to the corresponding terminal 190 in the docking success state of the robot cleaner 100. The docking device 200 may include a guide signal generating unit 220 that generates a docking guide signal for guiding the robot cleaner 100 to dock. The guide signal generating unit 220 generates an IR signal to guide the robot cleaner 100 to be docked with the docking device 200. Meanwhile, once the robot cleaner 100 is docked, the guide signal generating unit 220 stops generating the guide signal. If the robot cleaner 100 is released from the docking, the guide signal generating unit 220 may generate the guide signal. Namely, if the robot cleaner 100 is undocked from the docking device 200, the robot cleaner 100 is detached from the docking device 200 and needs to be guided so as to be docked with the docking device 200 after completing a task such as a cleaning or the like. The docking device 200 may be configured so as to be placed on the floor.

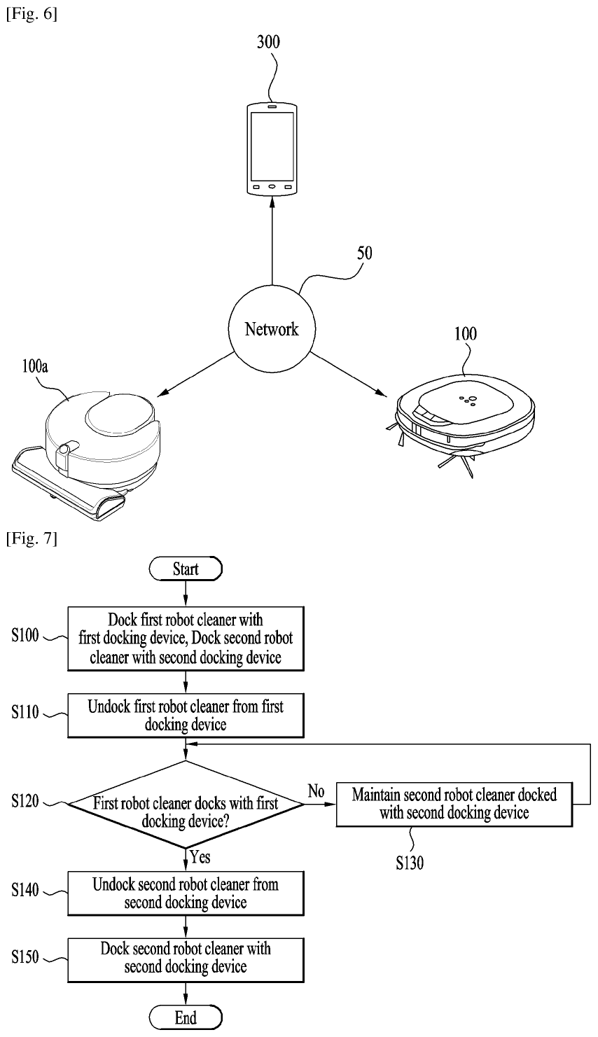

Referring to FIG. 6, one robot cleaner 100a may communicate with another robot cleaner 100b through a prescribed network. Each of the robot cleaners 100a and 100b may communicate with a terminal 300 via the prescribed network.

The communication unit 175 communicates with another device (e.g., another robot cleaner, a terminal, etc.) via the prescribed network. The prescribed network means a communication network connected by wire and/or wireless directly or indirectly. Namely, ‘the communication unit 175 communicates with another device via the prescribed network’ inclusively means a case that the communication unit 175 indirectly communicates with another device via the wireless router 400 or the like as well as a case that the communication unit 175 directly communicates with another device.

The network may be established based on Wi-Fi, Ethernet, Zigbee, Z-wave, Bluetooth, etc.

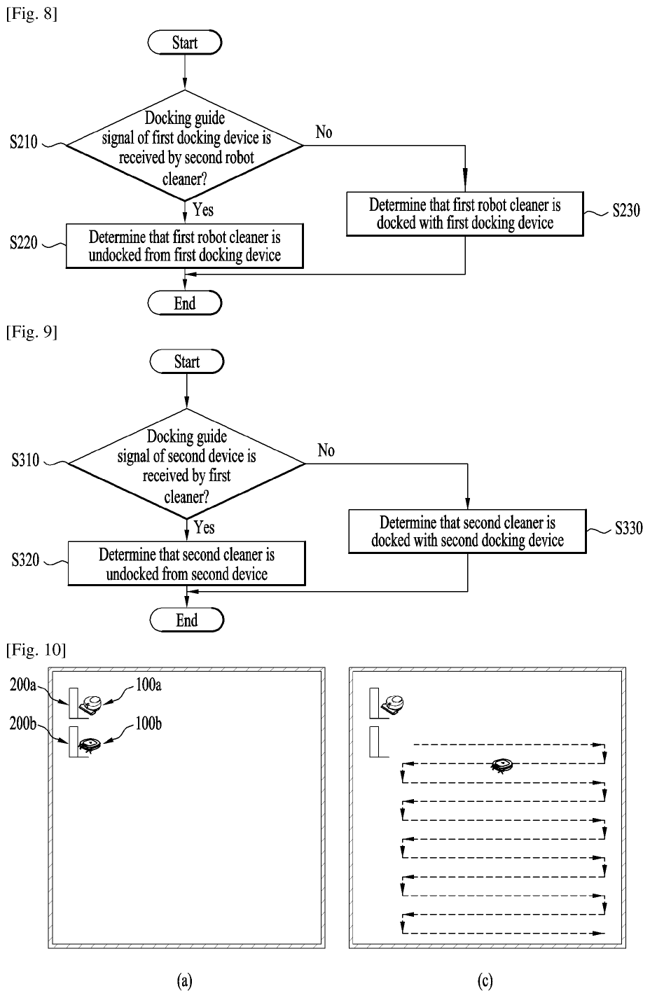

FIG. 7 is a control flowchart according to an embodiment of the present disclosure. FIG. 8 is a flowchart to describe an essential portion of FIG. 7. FIG. 9 is a flowchart to describe another essential portion of FIG. 7. FIG. 10 is a diagram to describe implementation of an embodiment according to FIG. 7.

Referring to FIGS. 7 to 10, a first robot cleaner 100a is docked with a first docking device 200a and a second robot cleaner 100b is docked with a second docking device 200b [S100]. As shown in FIG. 10 (a), the robot cleaners contact with the docking devices, respectively. Each of the first and second docking devices 200a and 200b includes the docking device described in FIG. 1, and the docking devices are provided to the robot cleaners, respectively. Here, each of the first and second docking devices 200a and 200b has the same configuration of the docking device but is docked with a different robot cleaner.

While the robot cleaner is docked with the docking devices, a battery of the robot cleaner may be charged. Meanwhile, once the robot cleaner is docked with the docking device, a guide signal generating unit 220 does not generate a guide signal. Namely, since the robot cleaner is currently docked with the docking device, it is unnecessary to guide the robot cleaner to the docking device, whereby the guide signal generating unit 220 does not generate a signal for guiding the robot cleaner to the docking device.

The first robot cleaner 100a is undocked from the first docking device 200a according to a user's command or a pre-stored program [S110]. In this case, a user may input a command through a user terminal 300 or command a task start through an input unit 171 provided to the first robot cleaner 100a.

As shown in FIG. 10 (b), if the first robot cleaner 100a is undocked from the first docking device 200a, the first robot cleaner 100a may perform the cleaning. The first robot cleaner 100a performs the cleaning in a manner of moving a cleaning-required section. In doing so, the first robot cleaner 100a may perform the cleaning according to a determined moving scheme. The first robot cleaner 100a may perform the cleaning in a manner of moving in a zigzag pattern not to miss a cleaning-required area.

After the first robot cleaner 100a has finished the cleaning, it is checked whether the first robot cleaner 100a is docked with the first docking device 200a [S120]. If the first robot cleaner 100a is not docked with the first docking device 200a, the first robot cleaner 100a may be determined as performing the cleaning or moving to the first docking device 100a currently [S130].

On the other hand, if the first robot cleaner 100a is docked with the first docking device 200a, the second robot cleaner 100b is undocked from the second docking device 200b [S140]. Once the second robot cleaner 100b is undocked from the second docking device 200b, the second robot cleaner 100 may perform the cleaning. As shown in FIG. 19 (c), the second robot cleaner 100b may clean the area that has been cleaned by the first robot cleaner 100a.

Since the second robot cleaner 100b performs the cleaning after the first robot cleaner 100a has been docked with the docking device, travel interference does not occur between the second robot cleaner and the first robot cleaner. Since the second robot cleaner is docked with the second docking device while the first robot cleaner is doing the cleaning, travel interference does not occur between the first robot cleaner and the second robot cleaner. In addition, since the first robot cleaner is docked with the first docking device while the second robot cleaner is doing the cleaning, travel interference does not occur between the first robot cleaner and the second robot cleaner.

For example, when the first robot cleaner is a dust-suction cleaner and the second Since the second robot cleaner is docked with the second docking device while the first robot cleaner is doing the cleaning, travel interference does not occur between the first robot cleaner and the second robot cleaner is a mopping cleaner, it is possible to perform the cleaning using two robot cleaners of different types. In addition, since the second robot cleaner cleans the area that has been cleaned by the first robot cleaner, the same area is cleaned twice to provide a user with a cleaner environment.

After the second robot cleaner 100b has performed the cleaning, as shown in FIG. 10 (d), it is docked with the second docking device 200b [S150]. If so, the cleaning of the same section can be completed by the first and second robot cleaners.

In some implementations, the guide signal generating unit provided to each of the docking devices 200a and 200b is receivable by all the robot cleaners 100a and 100b. A docking guide signal transmitted from the guide signal generating unit 220 of the first docking device 200a can be received by the first robot cleaner 100a and the second robot cleaner 100b. Moreover, a docking guide signal transmitted from the guide signal generating unit 220 of the second docking device 200b can be received by the first robot cleaner 100a and the second robot cleaner 100b. Namely, the guide signal generating unit generates an IR signal and a sensing unit of each of the robot cleaners can receive the IR signal.

Although the guide signal generating unit of the first docking device 200a transmits a docking guide signal, if the first robot cleaner 100a is docked with the first docking device 200a, the guide signal generating unit may not transmit the docking guide signal. If the first robot cleaner 100a is docked with the first docking device 200a, a docking sensing unit linked to a charging terminal 210 may sense the docking of the first robot cleaner. Hence, the guide signal generating unit does not generate a guide signal.

Although the guide signal generating unit of the second docking device 200b transmits a docking guide signal, if the second robot cleaner 100b is docked with the second docking device 200b, the guide signal generating unit may not transmit the docking guide signal. If the second robot cleaner 100b is docked with the second docking device 200b, a docking sensing unit linked to a charging terminal 210 may sense the docking of the second robot cleaner. Hence, the guide signal generating unit does not generate a guide signal.

As shown in FIG. 8, it is determined whether the second robot cleaner 100b receives the docking guide signal of the first docking device 200a [S210]. In doing so, the second robot cleaner 100b is currently docked with the second docking device 200b.

If the second robot cleaner 100b senses the guide signal transmitted from the first docking device, the first robot cleaner may be determined as undocked from the first docking device 200a [S220].

On the contrary, if the second robot cleaner 100b does not sense the guide signal transmitted from the first docking device, the first robot cleaner may be determined as docked with the first docking device 200a [S230].

As shown in FIG. 9, it is determined whether the first robot cleaner 100a receives the docking guide signal of the second docking device 200b [S310]. In doing so, the first robot cleaner 100a is currently docked with the first docking device 200a.

If the first robot cleaner 100a senses the guide signal transmitted from the second docking device, the second robot cleaner may be determined as undocked from the second docking device 200b [S320].

On the contrary, if the first robot cleaner 100a does not sense the guide signal transmitted from the second docking device, the second robot cleaner may be determined as docked with the second docking device 200b [S330].

As described above, while the first robot cleaner is docked with the first docking device, it may sense and determine whether the second robot cleaner is docked with the second docking device. Likewise, while the second robot cleaner is docked with the second docking device, it may sense and determine whether the first robot cleaner is docked with the first docking device. Therefore, only if the second robot cleaner is docked with the second docking device, the first robot cleaner may perform the cleaning by being undocked from the first docking device. Only if the first robot cleaner is docked with the first docking device, the second robot cleaner may perform the cleaning by being undocked from the second docking device.

To implement such features, while the second robot cleaner 100b is docked with the second docking device 200b, the first docking device 200a is disposed in a distance in which the second robot cleaner 100b can receive a docking guide signal transmitted by the first docking device 200a.

In addition, while the first robot cleaner 100a is docked with the first docking device 200a, the second docking device 200b is disposed in a distance in which the first robot cleaner 100a can receive a docking guide signal transmitted by the second docking device 200b.

Namely, each of the first docking device 200a and the second docking device 200b is disposed in a distance in which a robot cleaner docked with one docking device can receive a signal transmitted from a guide signal generating unit provided to the other docking device. If the guide signal generating unit includes an IR transmitting device, two docking devices are preferably disposed in about 5 meters. Of course, the two docking devices may be disposed in a distance shorter than 5 meters, whereby each of the robot cleaners can stably receive a signal transmitted from the docking device for the other robot cleaner.

It will be apparent to those skilled in the art that various modifications and variations can be made in the present disclosure without departing from the spirit or scope of the inventions. Thus, it is intended that the present disclosure covers the modifications and variations of this invention provided they come within the scope of the appended claims and their equivalents.

1. A method of controlling a plurality of robot cleaners, the method comprising:
docking a first robot cleaner at a first docking device, and docking a second robot cleaner at a second docking device;
determining that the first robot cleaner is undocked from the first docking device;
determining that the first robot cleaner is docked again at the first docking device after determining that the first robot cleaner is undocked from the first docking device, and
when the first robot cleaner is determined to be docked again at the first docking device, undocking the second robot cleaner from the second docking device.

2. The method of claim 1, comprising:
after determining that the first robot cleaner is undocked from the first docking device, performing cleaning by the first robot cleaner.

3. The method of claim 1, comprising:
performing cleaning by the second robot cleaner after the second robot cleaner is undocked from the second docking device.

4. The method of claim 1, comprising:
determining that the second robot cleaner is currently docked at the second docking device when the first robot cleaner does not receive a docking guide signal from the second docking device.

5. The method of claim 1, comprising:
determining that the first robot cleaner is currently docked at the first docking device when the second robot cleaner does not receive a docking guide signal from the first docking device.

6. The method of claim 1, wherein the first docking device is configured to not transmit a docking guide signal while the first robot cleaner is docked at the first docking device.

7. The method of claim 1, wherein the second docking device does is configured to not transmit a docking guide signal while the second robot cleaner is docked at the second docking device.

8. The method of claim 1, wherein a first docking guide signal transmitted from the first docking device is receivable by the first robot cleaner and the second robot cleaner, and a second docking guide signal transmitted from the second docking device is receivable by the first robot cleaner and the second robot cleaner.

9. The method of claim 8, wherein the first docking guide signal comprises a first infrared signal, and the second docking guide signal comprises a second infrared signal.

10-11. (canceled)

12. A robot cleaner system, comprising:
a first docking device that includes a first guide signal generator configured to transmit a first docking guide signal, and a first sensing device;
a second docking device that includes a second guide signal generator configured to transmit a second docking guide signal, and a second sensing device;
a first robot cleaner configured to perform cleaning and to dock at the first docking device; and
a second robot cleaner configured to perform cleaning and to dock at the second docking device,
wherein the first sensing device is capable of receiving a signal from the first guide signal generator and a signal from the second guide signal generator, and
wherein the second sensing device is capable of receiving a signal from the first guide signal generator and a signal from the second guide signal generator.

13. The robot cleaner system of claim 12, wherein the second robot cleaner is configured to receive the first docking guide signal from the first docking device while the second robot cleaner is docked at the second docking device.

14. The robot cleaner system of claim 12, wherein the first robot cleaner is configured to receive the second docking guide signal from the second docking device while the first robot cleaner is docked at the first docking device.

15. The robot cleaner system of claim 12, wherein the first guide signal generator of the first docking device is configured to transmit the first docking guide signal when the first robot cleaner is undocked from the first docking device, and
wherein when the first robot cleaner is docked at the first docking device, the first guide signal generator of the first docking device is configured to not transmit the first docking guide signal.

16. The robot cleaner system of claim 12, wherein the second guide signal generator of the second docking device is configured to transmit the second docking guide signal when the second robot cleaner is undocked from the second docking device, and
wherein when the second robot cleaner is docked at the second docking device, the second guide signal generator of the second docking device is configured to not transmit the second docking guide signal.

17. The robot cleaner system of claim 12, wherein while the second robot cleaner is docked at the second docking device, the first docking device is disposed within a distance in which the second robot cleaner is capable to receive the first docking guide signal from the first docking device.

18. The robot cleaner system of claim 12, wherein while the first robot cleaner is docked at the first docking device, the second docking device is disposed within a distance in which the first robot cleaner is capable to receive the second docking guide signal from the second docking device.

19. A method of controlling a plurality of robot cleaners, the method comprising:
docking a first robot cleaner at a first docking device;
docking a second robot cleaner at a second docking device;
determining that the first robot cleaner is undocked from the first docking device;
receiving, by the second robot cleaner, a docking guide signal from the first docking device,
after receiving the docking guide signal from the first docking device, determining that the docking guide signal is not being received at the second robot cleaner; and
when the first docking guide signal is determined to not being received at the second robot cleaner, undocking the second robot cleaner from the second docking device.

20. The method of claim 19, comprising:
after undocked the second robot cleaner at the second docking device, performing cleaning by the second robot cleaner.

21. The method of claim 19, wherein when the docking guide signal is received by the second robot cleaner, the first robot cleaner is undocked from the first docking device and the second robot cleaner is docked at the second docking device.

22. The method of claim 19, wherein when the docking guide signal is determined to not being received at the second robot cleaner, the first robot cleaner is determined to be docked at the first docking device.
